(19) United States
(12) Patent Application Publication
(10) Pub. No.: US 2021/0065235 A1
(43) Pub. Date: Mar. 4, 2021

(54) CONTENT PLACEMENT METHOD, DEVICE, ELECTRONIC APPARATUS AND STORAGE MEDIUM

(71) Applicant: Baidu Online Network Technology (Beijing) Co., Ltd., Beijing (CN)

(72) Inventors: Hongwei CAO, Beijing (CN); Lei ZHONG, Beijing (CN)

(73) Assignee: Baidu Online Network Technology (Beijing) Co., Ltd., Beijing (CN)

(21) Appl. No.: 16/792,480

(22) Filed: Feb. 17, 2020

(30) Foreign Application Priority Data
Aug. 30, 2019 (CN) 201910825646.6

(51) Int. Cl. G06Q 30/02; G10L 15/30; G10L 15/22; G10L 15/02; G10L 15/18; G06N 5/04

(52) U.S. Cl. CPC G06Q 30/0251; G10L 15/30; G10L 15/22; G10L 15/02; G10L 2015/227; G06N 5/04; G10L 2015/223; G10L 2015/228; G10L 15/1815

(57) ABSTRACT

A content placement method, device, electronic apparatus and a storage medium are provided. The specific implementation includes receiving voice information; generating first response data for the voice information; and placing a first content into the first response data according to the voice information, to generate second response data. In an embodiment, application service content corresponding to the voice information and the placed content can be seamlessly linked, so that a better placement effect is formed and user experience is good.

### CROSS-REFERENCE TO RELATED APPLICATION

This application claims priority to Chinese patent application No. 201910825646.6, filed on Aug. 30, 2019 and entitled “Content Placement Method, Device, Electronic Apparatus and Storage Medium”, which is hereby incorporated by reference in its entirety.

### TECHNICAL FIELD

The present application relates to a field of computer technology, and in particular, to an artificial intelligence technology.

### BACKGROUND

In content placement, content to be promoted is placed into currently presented information, so that more information elements can be included into the presented information. Taking “Product Placement” as an example, “Product Placement” refers to an advertising method in which a representative audiovisual brand symbol of a product and a service thereof is incorporated into film and television works or stage works. The Product Placement usually makes an impression on an audience to achieve a marketing purpose. An existing method for the Product Placement has the following defects: (1) Advertising content is usually placed in boot-up advertisements, but a frequency of being used for the boot-up advertisements is low. (2) The advertisements are mainly displayed on a screen, so that user experience is poor.

### SUMMARY

A content placement method, device, electronic apparatus, and a storage medium are provided according to embodiments of the present application, so as to solve at least the above technical problems in the existing technology.

According to a first aspect, a content placement method is provided according to an embodiment of the application, includes receiving voice information, generating first response data for the voice information, and placing a first content into the first response data according to the voice information, to generate second response data.

In an embodiment of the present application, application service content for the voice information and the placed content can be seamlessly linked, so that a better placement effect is formed, and user experience is good.

In an implementation, the placing a first content into the first response data according to the voice information, to generate second response data includes analyzing user information corresponding to the voice information, to acquire a user portrait corresponding to the voice information, and placing the first content into the first response data according to the user portrait corresponding to the voice information, to generate the second response data.

In embodiments of the present application, through analysis of the user information, advertisement content is placed based on the user portrait, so that the placed content better satisfies user needs, and can better provide the user with intelligent personalized services and the user experience is good.

In an implementation, the analyzing user information corresponding to the voice information, to acquire a user portrait corresponding to the voice information includes acquiring the user portrait corresponding to the voice information according to a context of the voice information, a search history of a user corresponding to the voice information, and personality information of the user corresponding to the voice information.

In embodiments of the present application, the user information is analyzed to acquire the user portrait, so as to provide the user with targeted services.

In an implementation, after the generating first response data for the voice information, the method further includes extracting a feature vector from the first response data.

In embodiments of the present application, the feature vector extracted from the first response data can be used for subsequent correlation analysis. Further, the correlation analysis performed by the feature vector can improve an efficiency and an accuracy for classification.

In an implementation, before the placing the first content into the first response data according to the user portrait corresponding to the voice information, to generate second response data, the method further includes receiving at least one second content to be placed.

In the embodiment of the present application, the content to be promoted provided by the content provider is received, so that a suitable part of the content is subsequently placed into the response data, and the placed content meet the user needs.

In an implementation, the placing the first content into the first response data according to the user portrait corresponding to the voice information, to generate second response data includes analyzing a correlation among the at least one second content, the user portrait corresponding to the voice information, and the feature vector; and acquiring the first content from the at least one second content according to a result of the analyzed correlation, and placing the first content into the first response data according to the voice information to generate the second response data.

In embodiments of the present application, the placed content better satisfies the user needs through the correlation analysis of the user portraits, the response data and content of the skill application services, so that intelligent personalized services can be better provided to the users, and the user experience is good.

According to a second aspect, a content placement method is provided in an embodiment of the application, including receiving voice information, requesting second response data from a server according to the voice information, wherein the second response data is generated according to first response data corresponding to the voice information, the voice information, and a first content, receiving the second response data, and determining the second response data as return information of the voice information.

In embodiments of the present application, on the basis of acquiring the response data of the skill application service, the second response data generated based on the user portrait is further requested, so that the content embedded in the return information better satisfies the user needs, intelligent personalized services can be better provided to the users, and the user experience is good.

In embodiments, the first response data is generated for the voice information; and the method further includes extracting a feature vector from the first response data.

In embodiments of the present application, the feature vector extracted from the first response data can be used for subsequent correlation analysis. Further, the correlation analysis performed by the feature vector can improve the efficiency and the accuracy for classification.

In an implementation, the method further includes receiving at least one second content to be placed.

In embodiments, the content to be promoted that is provided by the content provider is received, so that a suitable part of the content is subsequently placed into the response data. On one hand, a purpose of placing content from the content provider can be achieved, and on the other hand, the placed content meets also the user needs.

In an implementation, the method further includes analyzing a correlation among the at least one second content, a user portrait corresponding to the voice information, and the feature vector; and acquiring the first content from the at least one second content according to a result of the analyzed correlation, and placing the first content into the first response data to generate the second response data.

In embodiments, the placed content better satisfies the user needs, through the correlation analysis of the user portraits, the response data and content of the skill application services, so that intelligent personalized services can be better provided to the users, and the user experience is good.

According to a third aspect, a content placement device is provided in an embodiment of the application, includes a first receiving unit configured to receive voice information, a first generating unit configured to generate first response data for the voice information, and a second generating unit configured to place a first content into the first response data according to the voice information, to generate second response data.

In an implementation, the second generating unit comprises an analyzing subunit configured to analyze user information corresponding to the voice information, to acquire a user portrait corresponding to the voice information, and a generating subunit configured to place the first content into the first response data according to the user portrait corresponding to the voice information, to generate the second response data.

In an implementation, the analyzing subunit is configured to acquire the user portrait corresponding to the voice information according to a context of the voice information, a search history of a user corresponding to the voice information, and personality information of the user corresponding to the voice information.

In an implementation, the device further includes a first extracting unit configured to extract a feature vector from the first response data, after receiving the first response data,

In an implementation, the device further includes a second receiving unit configured to receive at least one second content to be placed.

In an implementation, the second generating unit is configured to analyze a correlation among the at least one second content, the user portrait corresponding to the voice information, and the feature vector; and acquire the first content from the at least one second content according to a result of the analyzed correlation, and place the first content into the first response data to generate the second response data.

According to a fourth aspect, a content placement device is provided in an embodiment of the application, includes a third receiving unit configured to receive voice information, a requesting unit configured to request second response data from a server according to the voice information, wherein the second response data is generated according to first response data corresponding to the voice information, the voice information, and a first content, a fourth receiving unit configured to receive the second response data, and a returning unit configured to determine the second response data as return information of the voice information.

In an implementation, the first response data is generated for the voice information, and the device further comprises a second extracting unit configured to extract a feature vector from the first response data.

In an implementation, the device further comprises a fifth receiving unit configured to receive at least one second content to be placed.

In an implementation, the device further includes a third generating unit configured to analyze a correlation among the at least one second content, a user portrait corresponding to the voice information, and the feature vector, and acquire the first content from the at least one second content according to a result of the analyzed correlation, and place the first content into the first response data to generate the second response data.

According to a fifth aspect, an electronic apparatus is provided in an embodiment of the application, includes at least one processor and a memory communicated with the at least one processor; wherein, instructions executable by the at least one processor is stored in the memory, and the instructions executed by the at least one processor to enable the at least one processor to implement the methods provided by any one of the embodiments of the present application.

According to a sixth aspect, a non-transitory computer-readable storage medium storing computer instructions is provided in an embodiment, wherein the computer instructions is configured to enable a computer to implement the methods provided by any one of the embodiments of the present application.

Various embodiments of the present disclosure have the following advantages or beneficial effects: through analysis of the user information, content is placed according to a user portrait, so that the placed content better satisfies user needs. Further, it is possible to better provide the user with intelligent personalized services and user experience is good.

Other effects of the foregoing optional manners will be described below in conjunction with specific embodiments.

### BRIEF DESCRIPTION OF THE DRAWINGS

The drawings are used to better understand the solution and are not to be considered as limiting the present application.

FIG. 1 is a schematic diagram of a content placement method according to an embodiment of the present application;

FIG. 2 is a flowchart of a content placement method according to an example of the present application;

FIG. 3 is a flowchart of a content placement method according to an embodiment of the present application;

FIG. 4 is a schematic structural diagram of an intelligent voice placement system according to an embodiment of the present application;

FIG. 5 is a structural schematic diagram of a content placement device according to an embodiment of the present application;

FIG. 6 is a structural schematic diagram of a content placement device according to an embodiment of the present application;

FIG. 7 is a structural schematic diagram of a content placement device according to an embodiment of the present application; and

FIG. 8 is a block diagram of an electronic apparatus for implementing a content placement method according to an embodiment of the present application.

### DETAILED DESCRIPTION

With reference to the accompanying drawings, exemplary embodiments of the present application are described below, which include various details of the embodiments of the present application to facilitate understanding and should be considered as merely exemplary. Therefore, those of ordinary skill in the art should recognize that various changes and modifications can be made to the embodiments described herein without departing from the scope and spirit of the application. Also, for clarity and conciseness, descriptions for public knowledge of functions and structures are omitted in the following descriptions.

FIG. 1 is a schematic diagram of a content placement method according to an embodiment of the present application. The embodiment shown in FIG. 1 can be applied to a conversational Artificial Intelligence (AI) system.

At S110, voice information can be received. At S120, second response data can be requested from a server according to the voice information. The second response data can be generated according to first response data corresponding to the voice information, the voice information, and a first content. At S130 the second response data can be received. At S140, the second response data can be determined as return information of the voice information.

More information elements can be incorporated into the presented information through content placement. Taking “Product Placement” as an example, “Product Placement” is a form of advertising that prevails with the development of movies, TV, games, and so on. A product or service of a merchant can be incorporated into a TV scenario and a game to achieve an unconsciously-influencing effect. The product placement can have a variety of presenting forms. Many suitable items and methods for placement can be found in the TV drama and entertainment programs. A common item for placement includes: goods, a logo, VI (a full name of which is Visual Identity, that is, a visual design for an enterprise VI, which is interpreted as a visual identity system), Corporate Identity (CI), a pack, a brand name, an enterprise mascot, and so on. In general, since a viewer has resistance to cut-in advertising, a method for placing advertising content into these entertainments is often more effective than a hard sell.

In an embodiment of the present application, the voice information of a user may be received through an intelligent voice device. For example, the user says to the intelligent voice device, “What's the weather like today?” The intelligent voice device sends the voice information to a conversational AI system. In S110, the conversational AI system receives voice information from the intelligent voice device.

In S120, the conversational AI system sends a response data request to the server according to the voice information. In one example, an intelligent voice placement system and a skill application service may be contained in the server. A corresponding skill application service is called by the server to acquire the response data for the voice information, that is, the first response data. In the above example, in the server, the user intention of acquiring the weather is identified, and then the corresponding skill application service, such as a “weather service” is called. By the “weather service”, the first response data is generated according to the user intention, such as “Today is rainy”. The first response data and voice information are then sent to the intelligent voice placement system.

By the intelligent voice placement system, the second response data is generated according to the first response data, the voice information, and the first content. Here, the first content is a content suitable to be placed, which is acquired by the intelligent voice placement system through correlation analysis. By the intelligent voice placement system, the first content is placed into the first response data according to the voice information, to generate the second response data. For example, the second response data as generated is: “Prompt from XX umbrella: today is rainy”.

In an embodiment, by the intelligent voice placement system, the first content is placed into the first response data according to a user portrait for the voice information, to generate the second response data. When the user portrait is constructed, specific information of the user can be abstracted into tags, and the user can be embodied by using these tags, so as to provide a targeted service for the user. An example for the user portrait may include: 1) the gender, an age group, a growth environment; 2) a life situation, a lifestyle, a habit; 3) character description, and an inner desire; 4) a consumer emotion, for example, things that the user likes or dislikes.

In S140, the second response data is processed to generate natural voice information, and the natural voice information as generated is determined as return information of the voice information to the intelligent voice device. For example, the return information is: “Prompt from XX umbrella: today is rainy, don't forget to bring an umbrella”. Finally, the return information is broadcasted to the user by the intelligent voice device.

In an embodiment, the first response data is generated for the voice information, and the above method further includes: extracting a feature vector from the first response data.

In this embodiment, a corresponding skill application service is called by the conversational AI system to acquire the response data for the voice information, that is, the first response data. For example, in a case that the user requests the weather condition, the corresponding skill application service, such as the “weather service”, is called. The first response data, such as “Today is rainy”, is generated by the “weather service” according to a user intention. The feature vector is extracted by the conversational AI system from the first response data. A form of the first response data may include a form of a text, an image, a video, and the like. For example, the returned content from the “weather service” is “Today is rainy xxx” and an image on a rainy day. The returned content from the skill application service can be analyzed to extract main members, that is, entities such as a noun and a verb are extracted from the returned content. The feature vector of the first response data is formed from a list of extracted entities.

In an embodiment of the present application, the feature vector extracted from the first response data can be used for subsequent correlation analysis. Further, by the correlation analysis performed according to the feature vector, an efficiency and accuracy for classification can be improved.

In one embodiment, the above method further includes: receiving at least one second content to be placed. Through a GUI (Graphical User Interface) or API (Application Programming Interface), a content provider can provide the content to be promoted, such as a text, an image, a video, and the like. The content provided by the content provider is referred to as the second content. In this embodiment, at least one second content to be placed is received by the conversational AI system.

In an embodiment of the present application, the content to be promoted that is provided by the content provider is received, so that a suitable part of the content is subsequently placed into the response data. On one hand, a content placement purpose of the content provider can be achieved; on the other hand, the placed content also meets user needs.

In one embodiment, the method further includes analyzing a correlation among the at least one second content, a user portrait corresponding to the voice information, and the feature vector; and acquiring the first content from the at least one second content according to a result of the analyzed correlation, and placing the first content into the first response data to generate the second response data

In this embodiment, the second response data may be generated in the conversational AI system. For example, a matching degree between the second content and the first response data may be calculated, and a matching degree between the second content and the user portrait may also be calculated. For example, there are multiple content providers that provide the second content. Taking “Product placement” as an example, an advertising content of sporting goods is provided by an advertiser A, an advertising content of agricultural products is provided by an advertiser B, and an advertising content of cosmetics is provided by an advertiser C. The user said: “What's the weather like today? I want to go running and exercise.” The user portrait for the user shows a sport hobby. The first response data returned by the skill application service according to the user intention is “Today is sunny, it is suitable for sports and outings” and images on sunny days. On one hand, the matching degree between the second content and the first response data is calculated. Further, since the advertising content of sporting goods is provided by the advertiser A, and the content of “suitable for sports” is included in the first response data, the matching degree between the advertising content from the Advertiser A and the first response data is relatively high. On the other hand, the matching degree between the second content and the user portrait is calculated. Since the advertising content of sporting goods is provided by the advertiser A, and a sport hobby is shown in the user portrait, the matching degree between the advertising content provided by Advertiser A and the user portrait is relatively high. Since the advertising content provided by Advertiser A has a relatively high matching degree with either of the first response data and the user portrait, the advertising content of the sports goods provided by the Advertiser A is selected from the second contents provided by multiple advertisers and placed into the first response data to generate the second response data. For example, it is generated: “Today is sunny, you can go running and outings. Putting on your sportswear and sneakers and going out to exercise! XX sneakers are on sale, a pair is for you.”

In an embodiment of the present application, the placed content better satisfies user needs, through the analysis of a correlation among the user portrait, the response data of the skill application service and the content. Further, it is possible to provide intelligent personalized services to the users, and the user experience is good.

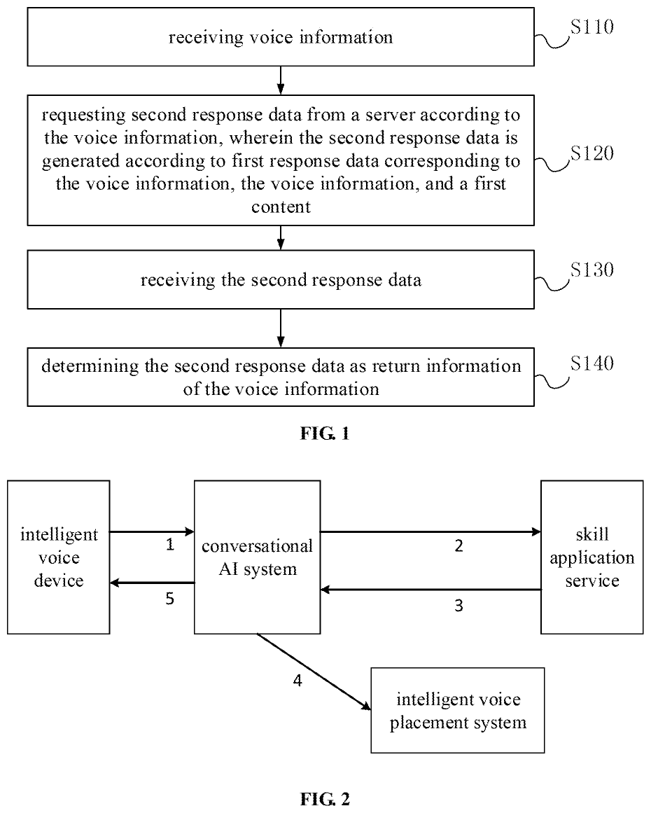

In an embodiment of the present application, a natural language processing technology is used to generate embedded voice broadcasting information according to content correlation, thereby achieving the purpose of placing content. Referring to FIG. 2, an exemplary process of a content placement method according to an embodiment of the present application is as follows.

1) The user says to the intelligent voice device, “What's the weather like today?” A data stream carrying voice information of the user is sent to the conversational AI system by the intelligent voice device.

2) Voice recognition and natural language processing on the data stream are performed by the conversational AI system. After identifying a user intention, a response data request is sent to the skill application service according to the user intention. For a specific topic, a business logic of the conversational AI system can be implemented through a skill application service. For example, the specific skill application service is a “weather service”.

3) By the specific skill application service, such as the “weather service”, a corresponding content is searched according to the user intention, and a content in the form of a text, an image, and the like is returned to the conversational AI system. For example, the content may be a text “Today is rainy xxx”, or an image on a rainy day.

4) The intelligent voice placement system is called by the conversational AI system. A correlation among user information (such as a search history and a search content), response data of the specific skill application service (such as a text “Today is rainy xxx”, an image on a rainy day, etc.) and the content provided by the content provider, such as the advertising content provided by the advertiser is performed by the intelligent voice placement system. Therefore, the response data of the specific skill application service is modified. For example, a modified result is “Prompt from XX umbrella: today is rainy xxx”. The modified result is returned by the intelligent voice placement system to the conversational AI system. Then, the modified result is processed to generate natural voice information by the conversational AI system, to acquire a final processing result.

5) The final processing result of the natural voice information as generated is returned by the conversational AI system to the intelligent voice device. In this example, a final response from the intelligent voice device to the user may be “Prompt from XX umbrellas: Today is rainy xxxx, don't forget to bring an umbrella, xxx”.

In another example, a conversation process can also be actively initiated by the conversational AI system and the intelligent voice device, both of which can be driven by the skill application service. For example, the “weather service” drives the conversational AI system and intelligent voice device to actively initiate to broadcast a weather forecast. The broadcast content provided by the weather service is “Today is rainy xxx”, an image on a rainy day, and the like. The broadcast content is sent to the conversational AI system by the “weather service”. The conversational AI system calls the intelligent voice placement system to perform content placement. The content placement method is similar to that described above. According to the user portrait of the registered user in the intelligent voice device, the content can be placed into the broadcast content generated by the “weather service”, to generate the final broadcast content.

In an embodiment of the present application, on the basis of acquiring the response data of the skill application service, it is further requested the second response data generated based on the user portrait, so that the content embedded in the return information better satisfies the user needs. In this way, an intelligent personalized service can be better provided to the user, and user experience is good.

FIG. 3 is a flowchart of a content placement method according to an embodiment of the present application. The embodiment shown in FIG. 3 may be applied to a server. The content placement method can include receiving voice information at S310, generating first response data for the voice information at S320, and placing a first content into the first response data according to the voice information, to generate second response data at S330.

As mentioned above, a conversational AI system requests the second response data from the server according to the voice information. The second response data is generated by the server according to the voice information and content suitable for placement.

In S310, the server receives the voice information from the conversational AI system. In S320, the first response data is generated by the server for the voice information from the conversational AI system. In one example, the server may include an intelligent voice placement system and a skill application service. The skill application service is configured to receive the voice information from the conversational AI system and return the first response data to the conversational AI system for the voice information. The skill application service is configured to perform voice recognition and natural language processing on the voice information to identify the user intention. For example, according to the voice information of the user “What's the weather like today?”, a user intention of acquiring weather is identified. A specific skill application service can be called according to the user intention, to acquire the response data for the voice information, that is, the first response data. In the above example, since the user intention of acquiring weather is identified, a specific skill application service “weather service” is called. The first response data, such as “Today is rainy”, is returned by the “weather service” according to the user intention. Then the voice information and the first response data are sent to the intelligent voice placement system by the conversational AI system, to request the second response data. In S330, by the intelligent voice placement system, the voice information and the first response data are received, and the first content suitable for placement is determined. The first content is placed into the first response data to generate the second response data.

In an embodiment of the present application, the application service content for the voice information and the placed content can be seamlessly linked, so that a better placement effect is formed and user experience is good.

In one embodiment, the placing a first content into the first response data according to the voice information, to generate second response data can include analyzing user information corresponding to the voice information, to acquire a user portrait corresponding to the voice information and placing the first content into the first response data according to the user portrait corresponding to the voice information, to generate the second response data.

As mentioned above, the conversational AI system can be configured to call the intelligent voice placement system according to the voice information and the first response data generated by the skill application service and request the second response data. The second response data is generated by the intelligent voice placement system according to the first response data, the user portrait for the voice information, and the content suitable for placement.

In this embodiment, based on the received voice information of the user, it is possible to identify an identity of the user, such as a registered account of the user. User information can be analyzed according to the identity of the user, to acquire a corresponding user portrait. Then, the first content suitable for placement is determined according to the user portrait. Finally, the first content is placed in the first response data to generate the second response data.

In embodiments of the present disclosure, through analysis of the user information, an advertising content is placed based on the user portrait, so that the placed content better satisfies user needs. Further, it is possible to better provide intelligent personalized services to the user and the user experience is good.

In one embodiment, the analyzing user information corresponding to the voice information, to acquire a user portrait corresponding to the voice information can include acquiring the user portrait corresponding to the voice information according to a context of the voice information, a search history of a user corresponding to the voice information, and personality information of the user corresponding to the voice information.

In this embodiment, the user information corresponding to the voice information may be acquired according to the received voice information of the user. For example, when the user is registered, personality information such as the voice information, an age, a gender, and hobbies of the user can be acquired. When the voice information of the user is received, a voiceprint recognition technology can be used to identify the registered account corresponding to the voice information of the registered user, thereby acquiring the personality information of the user. The user portrait can be constructed based on the personality information of the user, and the constructed user portrait can include the personality information such as an age, a gender, interests and hobbies and the like.

In one example, after the registered account of the user is identified, a search history of the user can also be acquired. For example, a search history of searching for the weather every day may be acquired. Context of the voice information can also be analyzed. For example, a search from the user is: “What's the weather like today”, and the voice information also has a context in which, for example, the user said, “What's the weather like today, I want to go running and exercise.” Through semantic analysis of the context, it can be known that the interest and hobby of the user is doing sports. A user portrait can be constructed based on the analysis the search history of the user and/or the context of the user search.

In subsequent processing, a suitable content can be placed based on the user portrait. In one embodiment, the user portrait may include an individual portrait and/or a group portrait. For example, the user portrait shows that a hobby of the user is doing sports, and the content such as sporting goods can be placed to meet personalized user needs.

In an embodiment of the present disclosure, the user information can be analyzed to acquire the user portrait, so as to provide the user with targeted services.

In an embodiment, after generating the first response data for the voice information, the method can further include extracting a feature vector from the first response data.

As described above, the corresponding content, that is, the first response data, is searched for by the skill application service according to the user intention and is returned to the conversational AI system. A form of the first response data may include a form of a text, an image, a video, and the like. For example, the returned content from the “weather service” is “Today is rainy xxx” and an image on a rainy day. The returned content from the skill application service can be analyzed to extract main members, that is, entities such as a noun and a verb are extracted from the returned content. The feature vector of the first response data is formed from a list of extracted entities.

In the embodiment of the present application, the feature vector extracted from the first response data can be used for subsequent correlation analysis. Further, by the correlation analysis performed according to the feature vector, an efficiency and accuracy for classification can be improved.

In one embodiment, before the placing the first content into the first response data according to the user portrait corresponding to the voice information, to generate second response data, the method can further include receiving at least one second content to be placed.

Content providers can provide the content to be promoted, such as a text, an image, a video, and the like, through a GUI (Graphical User Interface) or API (Application Programming Interface). The content provided by the content provider is referred to as the second content. After the intelligent voice placement system receiving the second content, a correlation between the second content and the first response data can be analyzed. In other words, after the content provider provides the content required to be promoted, the content can take effect in real time. In a case that the analyzed result shows that correlation is relatively large, the content can be placed.

In an embodiment of the present application, the content to be promoted that is provided by the content provider is received, so that a suitable part of the content is subsequently placed into the response data. On one hand, a content placement purpose of the content provider is achieved, and on the other hand, the placed content can meet the user needs.

In one embodiment, the placing the first content into the first response data according to the user portrait corresponding to the voice information, to generate second response data can include analyzing a correlation among the at least one second content, the user portrait corresponding to the voice information, and the feature vector; and acquiring the first content from the at least one second content according to a result of the analyzed correlation, and placing the first content into the first response data according to the voice information to generate the second response data.

In this embodiment, a matching degree between the second content and the first response data may be calculated, and a matching degree between the second content and the user's portrait may also be calculated. For example, there are multiple content providers that provide the second content. Taking “Product Placement” as an example, an advertising content of sporting goods is provided by an advertiser A, an advertising content of agricultural products is provided by an advertiser B, and an advertising content of cosmetics is provided by an advertiser C. The user said, “What's the weather like today? I want to go running and exercise.” and the user portrait for the user shows a sport hobby. The first response data returned by the skill application service according to the user intention is “Today is sunny, it is suitable for sports and outings” and images on sunny days. On one hand, the matching degree between the second content and the first response data is calculated. Further, since the advertising content of sporting goods is provided by the advertiser A, and the content of “suitable for sports” is included in the first response data, the matching degree between the advertising content and the first response data is relatively high. On the other hand, the matching degree between the second content and the user portrait is calculated. Since the advertising content of sporting goods is provided by the advertiser A, and a hobby is shown in the user portrait, the matching degree between the advertising content provided by Advertiser A and the user's portrait is relatively high. Since the advertising content provided by Advertiser A has a high matching degree with either of the first response data and the user portrait, the advertising content of the sports goods provided by the Advertiser A is selected from the second contents provided by multiple advertisers and placed into the first response data to generate the second response data. For example, it is generated: “Today is sunny, you can go running and on outings. Put on your sportswear and sneakers and go out to exercise! XX sneakers are on sale, a pair is for you.”

In the above example, when the first content with a high matching degree is searched in the second content, the first content is placed into the first response data. When the first content with a high matching degree is not searched in the second content, that is, no suitable content can be placed temporarily, a step of placing the content may not be performed. In this case, the intelligent voice placement system indicates, in the second response data returned to the conversational AI system, that no content is placed in the first response data.

In embodiments of the present disclosure the placed content better satisfies the user needs, through the correlation analysis of the user portraits, the response data and content of the skill application services, so that intelligent personalized services can be better provided to the users, and the user experience is good.

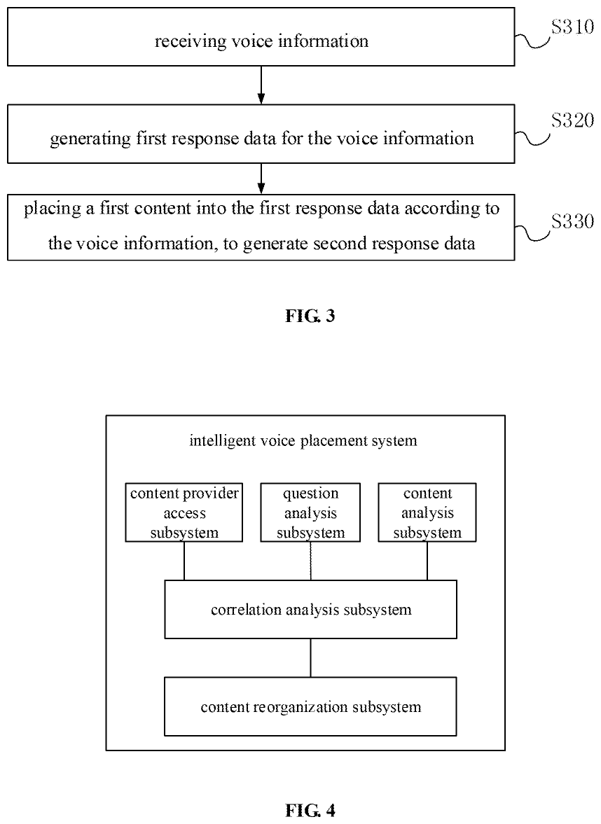

FIG. 4 is a schematic structural diagram of an intelligent voice placement system according to an embodiment of the present application. As shown in FIG. 4, in one example, the intelligent voice placement system may include a content provider access subsystem, a question analysis subsystem, a content analysis subsystem, a correlation analysis subsystem, and a content reorganization subsystem. The functions of each of these subsystems are as follows.

In the content provider access subsystem, a content provider provides the content to be promoted, such as text, pictures, videos, and the like through the GUI or API. The content provided by the content provider can be provided to the correlation analysis subsystem immediately and take effect in real time.

In the question analysis subsystem, questions of the user are analyzed according to a context, historical questions, user data such as the user personality information, and the like, to form a specific user portrait.

In the content analysis subsystem, the returned content, such as text, an image, a video, and the like, from the skill application service is analyzed, to extract a main component, and acquire the feature vector.

In the correlation analysis subsystem, a correlation among the content provided by multiple content providers, the user portrait, and the first response data returned from the skill application service is analyzed, to calculate the most suitable content for placement. The user portrait may include an individual portrait and/or a group portrait, for example, the question content and historical data of the user and other users of the same type.

In the content reorganization subsystem, the most suitable content is placed into the first response data returned by the skill application service through a certain algorithm (such as natural language generation technology) to form the second response data finally returned to the user.

FIG. 5 is a structural schematic diagram of a content placement device according to an embodiment of the present application. An embodiment shown in FIG. 5 may be applied to a server. The content placement device according to an embodiment of the present disclosure includes a first receiving unit 100 configured to receive voice information, a first generating unit 200 configured to generate first response data for the voice information, and a second generating unit 300 configured to place a first content into the first response data according to the voice information, to generate second response data.

In an implementation, the second generating unit 300 includes an analyzing subunit configured to analyze user information corresponding to the voice information, to acquire a user portrait corresponding to the voice information, and a generating subunit configured to place the first content into the first response data according to the user portrait corresponding to the voice information, to generate the second response data.

In an implementation, the analyzing subunit is configured to acquire the user portrait corresponding to the voice information according to a context of the voice information, a search history of a user corresponding to the voice information, and personality information of the user corresponding to the voice information.

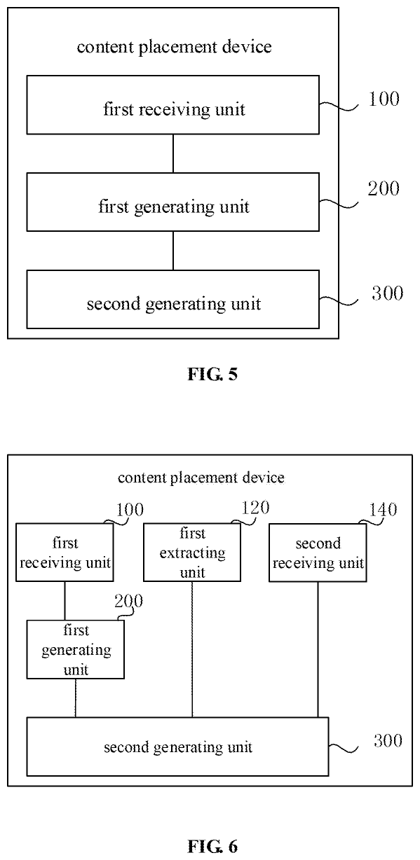

FIG. 6 is a structural schematic diagram of a content placement device according to an embodiment of the present application. As shown in FIG. 6, in an implementation, the device further comprises a first extracting unit 120 configured to extract a feature vector from the first response data, after receiving the first response data.

In an implementation, the device further comprises a second receiving unit 140 configured to receive at least one second content to be placed.

In an implementation, the second generating unit 300 is configured to analyze a correlation among the at least one second content, the user portrait corresponding to the voice information, and the feature vector; and acquire the first content from the at least one second content according to a result of the analyzed correlation, and place the first content into the first response data to generate the second response data.

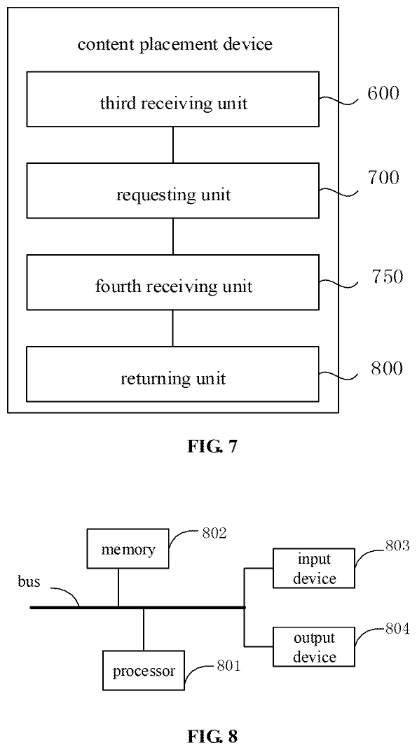

FIG. 7 is a structural schematic diagram of a content placement device according to an embodiment of the present application. An embodiment shown in FIG. 7 may be applied to a conversational AI system. As shown in FIG. 7, The content placement device according to an embodiment includes a third receiving unit 600 configured to receive voice information, a requesting unit 700 configured to request second response data from a server according to the voice information, wherein the second response data is generated according to first response data corresponding to the voice information, the voice information, and a first content, a fourth receiving unit 750 configured to receive the second response data, and a returning unit 800 configured to determine the second response data as return information of the voice information.

In an implementation, the first response data is generated for the voice information; and the device further comprises a second extracting unit configured to extract a feature vector from the first response data.

In an implementation, the above device further includes a fifth receiving unit configured to receive at least one second content to be placed.

In an implementation, the above device further comprises a third generating unit configured to analyze a correlation among the at least one second content, the user portrait corresponding to the voice information, and the feature vector; and acquire the first content from the at least one second content according to a result of the analyzed correlation and place the first content into the first response data to generate the second response data.

In this embodiment, functions of units in the content placement device refer to the corresponding description of the above-mentioned methods and thus the description thereof are omitted herein.

According to an embodiment of the present application, the present application further provides an electronic apparatus and a readable storage medium.

As shown in FIG. 8, it is a block diagram of an electronic apparatus according to the content placement method according to the embodiment of the present application. The electronic apparatus is intended to represent various forms of digital computers, such as laptop computers, desktop computers, workbenches, personal digital assistants, servers, blade servers, mainframe computers, and other suitable computers. Electronic apparatus may also represent various forms of mobile devices, such as personal digital processing, cellular phones, intelligent phones, wearable devices, and other similar computing devices. The components shown here, their connections and relationships, and their functions are merely examples, and are not intended to limit the implementation of the application described and/or required herein.

As shown in FIG. 8, the electronic apparatus includes: one or more processors 801, a memory 802, and interfaces for connecting various components, including a high-speed interface and a low-speed interface. The various components are interconnected using different buses and can be mounted on a common motherboard or otherwise installed as required. The processor may process instructions executed within the electronic apparatus, including storing in or on a memory to display a graphical user interface (GUI) on an external input/output device such as a display device coupled to the interface) Graphic information instructions. In other embodiments, multiple processors and/or multiple buses can be used with multiple memories and multiple memories, if desired. Similarly, multiple electronic apparatus can be connected, each providing some of the necessary operations (for example, as a server array, a group of blade servers, or a multiprocessor system). A processor 801 is taken as an example in FIG. 8.

The memory 802 is a non-transitory computer-readable storage medium provided by the present application. The memory stores instructions executable by at least one processor, so that the at least one processor executes the content placement method provided in the present application. The non-transitory computer-readable storage medium of the present application stores computer instructions, which are used to cause a computer to execute the content placement method provided by the present application.

As a non-transitory computer-readable storage medium, the memory 802 can be used to store non-transitory software programs, non-transitory computer executable programs, and modules, such as program instructions corresponding to the content placement method in the embodiments of the present application. Module/unit (for example, the first receiving unit 100, the first generating unit 200, the second generating unit 300 shown in FIG. 5, the first extracting unit 120, the second receiving unit 140 shown in FIG. 6, or the third receiving unit 600, the requesting unit 700, the fourth receiving unit 750, and the returning unit 800 shown in FIG. 7). The processor 801 executes various functional applications and data processing of the server by running non-transitory software programs, instructions, and modules stored in the memory 802, that is, the content placement method in the embodiments of the foregoing method can be implemented.

The memory 802 may include a storage program area and a storage data area, where the storage program area may store an operating system and an application program required for at least one function; the storage data area may store data created according to the use of the electronic device of the content placement method, etc. In addition, the memory 802 may include a high-speed random access memory, and may also include a non-transitory memory, such as at least one magnetic disk storage device, a flash memory device, or other non-transitory solid-state storage device. In some embodiments, the memory 802 may optionally include a memory remotely set relative to the processor 801, and these remote memories may be connected to the electronic apparatus with the content placement method through a network. Examples of the above network include, but are not limited to, the Internet, an intranet, a local area network, a mobile communication network, and combinations thereof.

The electronic apparatus with the content placement method may further include an input device 803 and an output device 804. The processor 801, the memory 802, the input device 803, and the output device 804 may be connected through a bus or in other manners. In FIG. 8, the connection through the bus is taken as an example.

The input device 803 can receive inputted numeric or character information, and generate key signal inputs related to user settings and function control of an electronic apparatus for content placement method, such as a touch screen, a keypad, a mouse, a trackpad, a touchpad, a pointing stick, one or more mouse buttons, a trackball, a joystick and other input devices. The output device 804 may include a display device, an auxiliary lighting device (for example, an LED), a haptic feedback device (for example, a vibration motor), and the like. The display device may include, but is not limited to, a liquid crystal display (Liquid Crystal Display, LCD), a light emitting diode (Light Emitting Diode, LED) display, and a plasma display. In some embodiments, the display device may be a touch screen.

Various implementations of the systems and technologies described herein can be implemented in digital electronic circuit systems, integrated circuit systems, application specific integrated circuits (ASICs), a computer hardware, a firmware, a software, and/or combinations thereof. These various embodiments may include: implementation in one or more computer programs executable on and/or interpretable on a programmable system including at least one programmable processor, which may be a dedicated or general-purpose programmable processor that may receive data and instructions from a storage system, at least one input device, and at least one output device, and transmit the data and instructions to the storage system, the at least one input device, and the at least one output device.

These computing programs (also known as programs, software, software applications, or code) include machine instructions of a programmable processor and can be implemented using high-level procedural and/or object-oriented programming languages, and/or assembly/machine languages. As used herein, the terms “machine-readable medium” and “computer-readable medium” refer to any computer program product, device, and/or device used to provide machine instructions and/or data to a programmable processor (for example, magnetic disks, optical disks, memories, and programmable logic devices (PLD)), include machine-readable media that receives machine instructions as machine-readable signals. The term “machine-readable signal” refers to any signal used to provide machine instructions and/or data to a programmable processor.

In order to provide interaction with the user, the systems and techniques described herein may be implemented on a computer having a display device (for example, a CRT (Cathode Ray Tube) or LCD (liquid crystal display) monitor) for displaying information to the user; and a keyboard and pointing device (such as a mouse or trackball) through which the user can provide input to a computer. Other kinds of devices may also be used to provide interaction with the user; for example, the feedback provided to the user may be any form of sensory feedback (for example, visual feedback, auditory feedback, or haptic feedback); and may be in any form (including acoustic input, voice input, or tactile input) to receive input from the user.

The systems and technologies described herein can be implemented in a subscriber computer of a computing system including background components (for example, as a data server), a computing system including middleware components (for example, an application server), or a computing system including front-end components (for example, a user computer with a graphical user interface or a web browser, through which the user can interact with the implementation of the systems and technologies described herein), or a computer system including such background components, middleware components, or any combination of front-end components. The components of the system may be interconnected by any form or medium of digital data communication (such as, a communication network). Examples of communication networks include: a local area network (LAN), a wide area network (WAN), and the Internet.

Computer systems can include clients and servers. The client and server are generally remote from each other and typically interact through a communication network. The client-server relationship is generated by computer programs running on the respective computers and having a client-server relationship with each other.

According to the technical solution of the embodiment of the present application, points of interest are directly identified from related content of user's information behavior, thereby ensuring that the points of interest pushed for the user can match the intention of the user, and the user's experience is good. Because the points of interest are directly identified from the relevant content of the user's information behavior, the problem that the pushed points of interest do not meet the user's needs is avoided, thereby improving the user's experience.

It should be understood that the various forms of processes shown above can be used to reorder, add, or delete steps. For example, the steps described in this application can be executed in parallel, sequentially, or in different orders. As long as the desired results of the technical solutions disclosed in this application can be achieved, there is no limitation herein.

The foregoing specific implementation manners do not constitute a limitation on the protection scope of the present application. It should be understood by those skilled in the art that various modifications, combinations, sub-combinations, and substitutions may be made according to design requirements and other factors. Any modification, equivalent replacement and improvement made within the spirit and principle of this application shall be included in the protection scope of this application.

What is claimed is:

1. A content placement method, comprising:
receiving voice information;
generating first response data for the voice information; and
placing a first content into the first response data according to the voice information, to generate second response data.

2. The content placement method of claim 1, wherein the placing a first content into the first response data according to the voice information, to generate second response data comprises:
analyzing user information corresponding to the voice information, to acquire a user portrait corresponding to the voice information; and
placing the first content into the first response data according to the user portrait corresponding to the voice information, to generate the second response data.

3. The content placement method of claim 2, wherein the analyzing user information corresponding to the voice information, to acquire a user portrait corresponding to the voice information comprises:
acquiring the user portrait corresponding to the voice information according to a context of the voice information, a search history of a user corresponding to the voice information, and personality information of the user corresponding to the voice information.

4. The content placement method of claim 3, wherein after the generating first response data for the voice information, the method further comprises:
extracting a feature vector from the first response data.

5. The content placement method of claim 4, wherein before the placing the first content into the first response data according to the user portrait corresponding to the voice information, to generate second response data, the method further comprises:
receiving at least one second content to be placed.

6. The content placement method of claim 5, wherein the placing the first content into the first response data according to the user portrait corresponding to the voice information, to generate second response data comprises:
analyzing a correlation among the at least one second content, the user portrait corresponding to the voice information, and the feature vector; and acquiring the first content from the at least one second content according to a result of the analyzed correlation; and
placing the first content into the first response data to generate the second response data.

7. A content placement method, comprising:
receiving voice information;
requesting second response data from a server according to the voice information, wherein the second response data is generated according to first response data corresponding to the voice information, the voice information, and a first content;
receiving the second response data; and
determining the second response data as return information of the voice information.

8. The content placement method of claim 7, wherein the first response data is generated for the voice information, and the method further comprises: extracting a feature vector from the first response data.

9. The content placement method of claim 8, further comprising: receiving at least one second content to be placed.

10. The content placement method of claim 9, further comprising:
analyzing a correlation among the at least one second content, a user portrait corresponding to the voice information, and the feature vector; and acquiring the first content from the at least one second content according to a result of the analyzed correlation; and
placing the first content into the first response data to generate the second response data.

11. A content placement device, comprising:
one or more processors; and
a storage device configured for storing one or more programs, wherein
the one or more programs are executed by the one or more processors to enable the one or more processors to:
receive voice information;
generate first response data for the voice information; and
place a first content into the first response data according to the voice information, to generate second response data.

12. The content placement device of claim 11, wherein the one or more programs are executed by the one or more processors to enable the one or more processors further to:
analyze user information corresponding to the voice information, to acquire a user portrait corresponding to the voice information; and
place the first content into the first response data according to the user portrait corresponding to the voice information, to generate the second response data.

13. The content placement device of claim 12, wherein the one or more programs are executed by the one or more processors to enable the one or more processors further to:
acquire the user portrait corresponding to the voice information according to a context of the voice information, a search history of a user corresponding to the voice information, and personality information of the user corresponding to the voice information.

14. The content placement device of claim 13, wherein the one or more programs are executed by the one or more processors to enable the one or more processors further to:
extract a feature vector from the first response data, after receiving the first response data.

15. The content placement device of claim 14, wherein the one or more programs are executed by the one or more processors to enable the one or more processors further to:
receive at least one second content to be placed.

16. The content placement device of claim 15, wherein the one or more programs are executed by the one or more processors to enable the one or more processors further to:
analyze a correlation among the at least one second content, the user portrait corresponding to the voice information, and the feature vector; and acquire the first content from the at least one second content according to a result of the analyzed correlation; and
place the first content into the first response data to generate the second response data.

17. An electronic apparatus, comprising:
at least one processor; and
a memory communicated with the at least one processor; wherein,
instructions executable by the at least one processor are stored in the memory, and the instructions are executed by the at least one processor, to enable the at least one processor to implement the method of claim 1.

18. A non-transitory computer-readable storage medium, in which instructions of a computer are stored, wherein the instructions are configured to enable the computer to implement the method according to claim 1.
